(19) United States
(12) Patent Application Publication
(10) Pub. No.: US 2010/0293309 A1
(43) Pub. Date: Nov. 18, 2010

(54) Production Tool For Low-Level Format Of A Storage Device

(76) Inventors: Yun-Ching Lin, Hsinchu (TW); Chih-Cheng Tu, Hsinchu (TW); Chih-Hwa Chang, Hsinchu (TW); Yung-Li Ji, Hsinchu (TW); Fu-Chen Cheng, Hsinchu (TW)

Correspondence Address: SQUIRE, SANDERS & DEMPSEY L.L.P., 275 BATTERY STREET, SUITE 2600, SAN FRANCISCO, CA, 94111-3356, US

(21) Appl. No.: 12/465,552

(22) Filed: May 13, 2009

(51) Int. Cl. G06F 13/42

(52) U.S. Cl. 710/66

(57) ABSTRACT

A production tool for low-level format of a storage device is disclosed. The production tool includes an input connector connectable and an output connector, both of which conform to an interface standard. At least a redundant pin of the input connector is unconnected with a corresponding redundant pin of the output connector, and the redundant pin of the output connector is electrically connected to receive a provided predetermined signal, the presence of which indicating a low-level format mode.

### BACKGROUND OF THE INVENTION

1. Field of the Invention

The present invention generally relates to storage device, and more particularly to the production tool for low-level format of the storage device.

2. Description of the Prior Art

Solid-state drive (SSD), such as flash-based SSD, is a data storage device that has gradually appeared in modern electronic devices, particularly laptop computers or digital audio players (commonly known as MP3 players) because of it being faster and lighter than conventional hard disk drive. The SSD (as well as the hard disk drive) commonly communicates with a host through a storage-interface such as serial advanced technology attachment (SATA).

In order to prepare an SSD for an end user, system manufacturer need perform low-level format on a new flash memory out of the factory. In the process of the low-level format, system manufacturer determines and records defect block(s) according to the value stored in spare area of the flash memory provided by the factory. On the other hand, low-level format is also required in case that the recorded defect block(s) are mistakenly damaged by the user.

There are various schemes for performing the low-level format on the SSD. FIG. 1 shows a schematic diagram illustrating a first conventional scheme for performing the low-level format. In this scheme, the host 10 issues command sequence to the SSD 12 through SATA in order to switch the SSD 12 to the low-level format (LLF) mode from a normal mode. The scheme is straightforward but the SSD 12 (even in its normal mode) is liable to menace, such as virus, from the Internet 14 in case that the command sequence has been cracked or leaked out.

FIG. 2 shows a schematic diagram illustrating a second conventional scheme for performing the low-level format. In this scheme, a switch 22 is installed on the SSD 20. When the switch 22 is in the normal mode that electrically connects, for example, to power VCC, the SSD 20 is ready for use in normal mode. On the other hand, when the switch is in the low-level format (LLF) mode that electrically connects, for example, to ground GND, the SSD 20 is ready for low-level format. This scheme causes inconvenience as the enclosure (not shown in the figure) that encloses the SSD 20 should be removed before the mode can be switched in case of repairing or low-level formatting the SSD 20.

FIG. 3 shows a schematic diagram illustrating a third conventional scheme for performing the low-level format. In this scheme, the host 30 issues command sequence to a USB-to-SATA circuit 32 through universal serial bus (USB). The USB-to-SATA circuit 32 converts the command and then forwards the converted command to the SSD 34 through SATA in order to switch to the low-level format (LLF) mode from a normal mode. As the LLF path is indirect, the SSD 34 is capable of blocking menace from the Internet. However, the communication latency in this scheme is high, compared to the first scheme (FIG. 1), and extra cost and time are required in developing the firmware that controls the USB-to-SATA circuit 32.

For the reason that conventional schemes could not both efficiently and economically perform low-level format on the data storage device, such as the SSD, a need has arisen to propose an effective production tool for low-level format of the storage device.

### SUMMARY OF THE INVENTION

In view of the foregoing, it is an object of the present invention to provide a production tool for low-level format of the storage device that may block menace from the Internet, eliminate inconvenience in use or avoid extra converting device.

According to one embodiment, the production tool includes an input connector connectable to a host and an output connector connectable to a storage device. The input connector conforms to an interface standard that is compatible with the interface standard of the output connector. At least a redundant pin of the input connector is unconnected with a corresponding redundant pin of the output connector, and the redundant pin of the output connector is electrically connected to receive a provided predetermined signal, the presence of which indicating a low-level format mode.

### BRIEF DESCRIPTION OF THE DRAWINGS

FIG. 1 shows a schematic diagram illustrating a first conventional scheme for performing the low-level format;

FIG. 2 shows a schematic diagram illustrating a second conventional scheme for performing the low-level format;

FIG. 3 shows a schematic diagram illustrating a third conventional scheme for performing the low-level format;

FIG. 4A shows a block diagram that illustrates a production tool for low-level format of a storage device according to one embodiment of the present invention;

FIG. 4B shows a block diagram illustrating that the storage device is configured to be directly connected to the host bypassing the production tool;

FIG. 5A shows a schematic diagram that illustrates a production tool for low-level format of an SSD according to a specific first embodiment of the present invention;

FIG. 5B shows a schematic diagram illustrating that the SSD in FIG. 5A is configured to be directly connected to the host bypassing the production tool;

FIG. 6A shows a schematic diagram that illustrates a production tool for low-level format of an SSD according to a specific second embodiment of the present invention;

FIG. 6B shows a schematic diagram illustrating that the SSD in FIG. 6A is configured to be directly connected to the host bypassing the production tool;

FIG. 7A shows a schematic diagram that illustrates a production tool for low-level format of an SSD according to a specific third embodiment of the present invention; and

FIG. 7B shows a schematic diagram illustrating that the SSD in FIG. 7A is configured to be directly connected to the host bypassing the production tool.

### DETAILED DESCRIPTION OF THE INVENTION

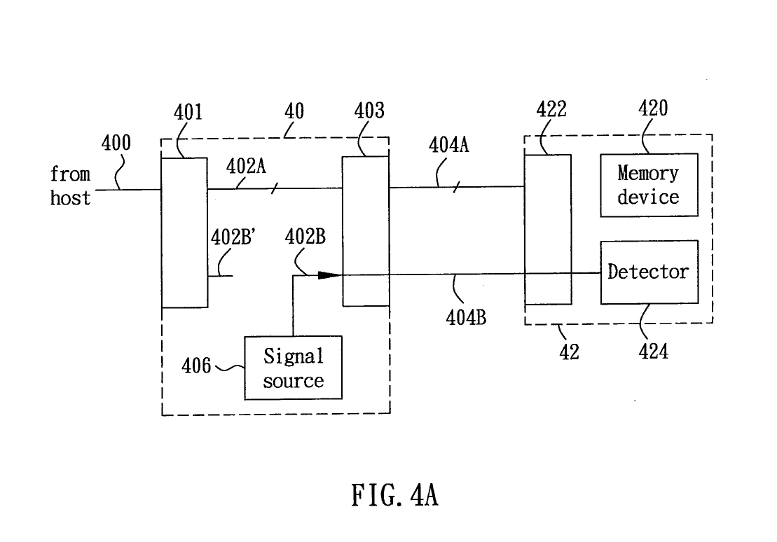

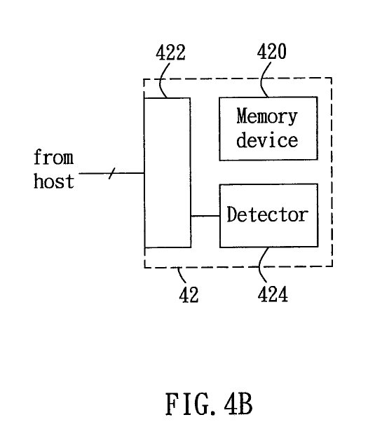

FIG. 4A shows a block diagram that illustrates a production tool (or text fixture) 40 for low-level format of a storage device 42 according to one embodiment of the present invention. In the embodiment, the term “low-level format” is referring to writing program or firmware, from a host, into the memory device 420 for the use of the memory controller (not shown in the figure). The term “low-level format” may further refer to verifying the memory device 420 such as flash memory.

In the embodiment, the production tool 40 includes an input connector 401 and an output connector 403. The input connector 401 may be connected to a host, for example, through a cable 400; and the output connector 403 may be connected to the storage device 42. The input connector 401 conforms to an interface standard that is the same or at least compatible with that of the output connector 403. In the embodiment, the interface may be a storage-interface for connecting a host to a storage device. One of the storage-interface may be, but not limited to, the serial advanced technology attachment (SATA), which will be described in detail later in this specification.

Between the input connector 401 and the output connector 403 are a number of signal/power lines 402A and at least a pair of unconnected lines 402B and 402B′. According to the figure, the line 402B is not connected to the line 402B′ but is connected to a signal source 406 (such as a clock generator), which may be within or external to the production tool 40. The line 402B or 402B′ corresponds to a redundant pin of the storage-interface. In the embodiment, the term “redundant” means that something is more than needed (e.g., is duplicate) or something that is not used. The significance concerning the redundant pin will be evident later in this specification as more embodiments are discussed. The output connector 403 may be connected to a storage-device connector 422 through a number of lines 404A and at least a line 404B, which directly communicates electrically with the unconnected line 402B.

When the storage device 42 is configured to be indirectly connected to the host through the production tool 40 as shown in FIG. 4A, a detector 424 detects the presence of the generated signal from the signal source 406 through the lines 404B and 402B. The detector 424 may be part of the memory controller resided in the storage device 42, and may be implemented either in software/firmware or hardware. Upon detection of the generated signal, the storage device 42 may then switch to the low-level format (LLF) mode to perform low-level format by the host. On the contrary, when the storage device 42 is configured to be directly connected to the host bypassing the production tool 40 as shown in FIG. 4B, the detector 424 detects the absence of the generated signal, and the storage device 42 may then switch to the normal mode. In the embodiment, the generated signal from the signal source 406 may, in general, a predetermined signal that is substantially distinguishable from the signal defined in the associated pin corresponding to the line 402B or 402B′. In this. specification, the term “signal” may refer to either signal or power potential.

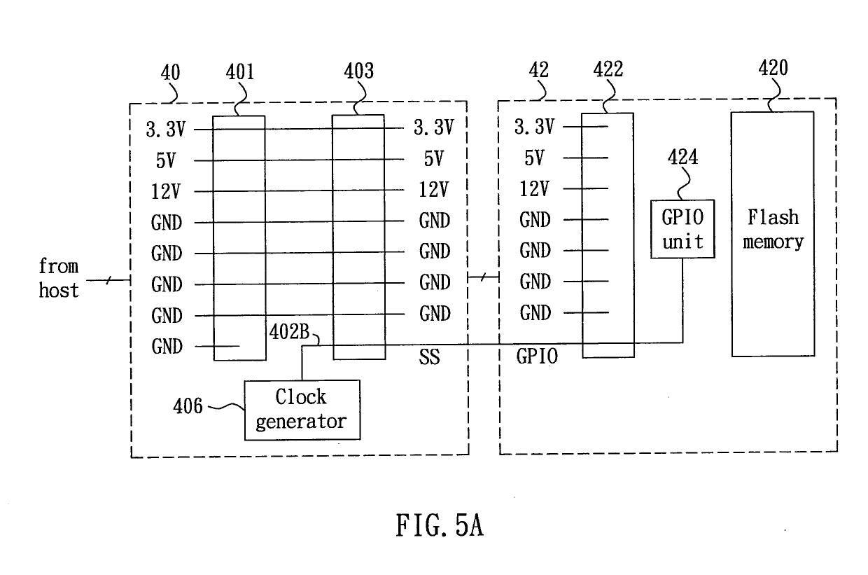

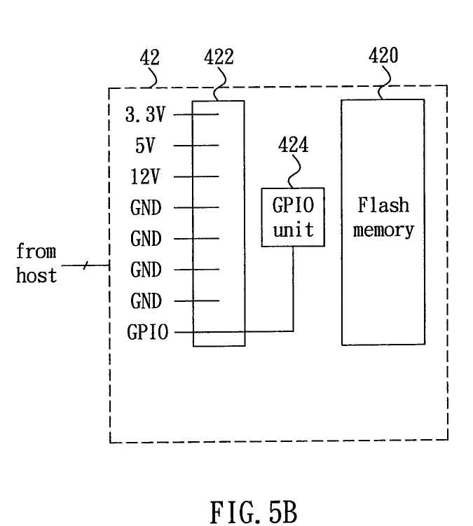

FIG. 5A shows a schematic diagram that illustrates a production tool (or text fixture) 40 for low-level format of an SSD 42 (particularly a flash-based SSD) according to a specific first embodiment of the present invention. The blocks similar to or the same as those in FIG. 4A are denoted with the same labels. The present embodiment adopts the SATA interface standard, and the figure shows only partial pins defined in the interface standard for illustrative purpose. The SATA interface standard includes two segments-the signal segment and the power segment, the pinout of which is shown in the following table 1.

TABLE 1

| | Pin Name | Function |
|---|---|---|
| Signal Segment | S1 | GND |
| | S2 | A+ |
| | S3 | A− |
| | S4 | GND |
| | S5 | B− |
| | S6 | B+ |
| | S7 | GND |
| Power Segment | P1 | 3.3 V |
| | P2 | 3.3 V |
| | P3 | 3.3 V |
| | P4 | GND |
| | P5 | GND |
| | P6 | GND |
| | P7 | 5 V |
| | P8 | 5 V |
| | P9 | 5 V |
| | P10 | GND |
| | P11 | DAS/DSS |
| | P12 | GND |
| | P13 | 12 V |
| | P14 | 12 V |
| | P15 | 12 V |

Regarding the production tool 40 in FIG. 5A, the SATA input connector 401 includes, in the embodiment, portion of the SATA power segment: 3.3V, 5V, 12V, and five ground (GND) pins. The SATA output connector 403 includes all of these pins except one ground (GND) pin. In other words, one ground (GND) pin is chosen as the redundant pin. A clock generator 406 then provides clock signal to the unconnected or redundant pin SS through the line 402B. It is appreciated that the signal source 406 may not necessarily provide clock signal. In this exemplary embodiment, a signal source 406 providing any signal distinguishable from the ground level will be adequate. For example, a signal source 406 providing, for example, 5V power level is sufficiently distinguishable from the ground level.

Regarding the SSD 42 in FIG. 5A, the SATA SSD connector 422 includes al pins of the SATA output connector 403, and in particular the redundant pin SS is connected with a detection pin GPIO, which is further connected to a general purpose input/output (GPIO) unit 424 that is capable of detecting the presence or absence of the predetermined signal from the clock generator 406. The GPIO unit 424 may reside in and be part of the memory controller (not shown in the figure) in charge of controlling the access of the flash memory 420.

When the SSD 42 is configured to be indirectly connected to the host through the production tool 40 as shown in FIG. 5A, the GPIO unit 424 detects the presence of the generated clock signal from the clock generator 406 through the line 402B and pins SS and GPIO. Upon detection of the generated clock signal, the SSD 42 may then switch to the low-level format (LLF) mode to perform low-level format by the host. On the contrary, when the SSD 42 is configured to be directly connected to the host bypassing the production tool 40 as shown in FIG. 5B, the GPIO unit 424 detects the absence of the generated signal (and the presence of the ground level), and the SSD 42 may then switch to the normal mode.

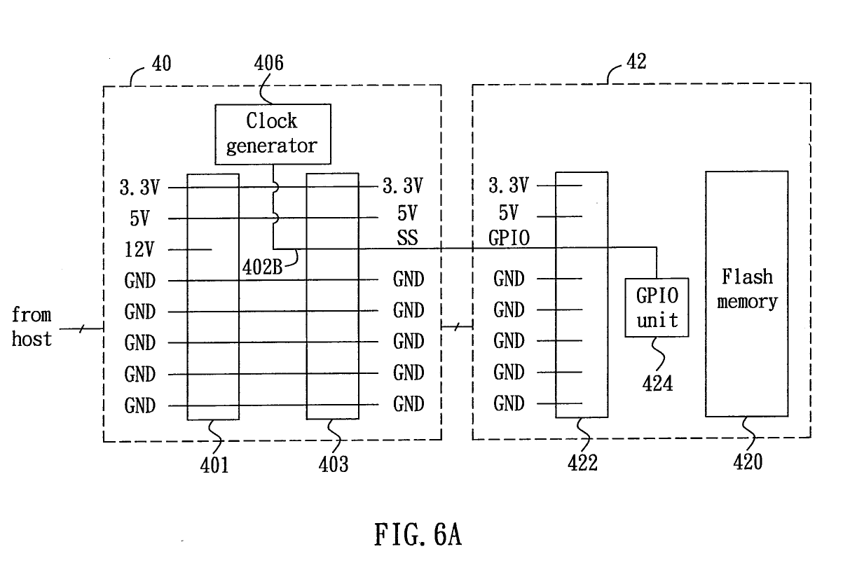

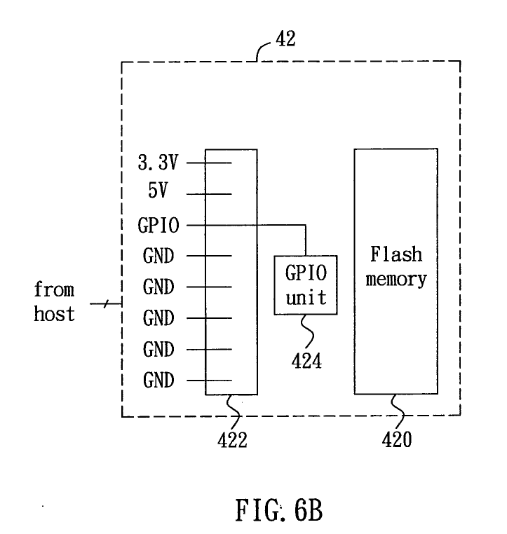

FIG. 6A shows a schematic diagram that illustrates a production tool 40 for low-level format of an SSD 42 (particularly a flash-based SSD) according to a specific second embodiment of the present invention.

Regarding the production tool 40 in FIG. 6A, the SATA input connector 401 includes, in the embodiment, portion of the SATA power segment: 3.3V, 5V, 12V, and five ground (GND) pins. The SATA output connector 403 includes all of these pins except one unused power pin (for example, 12V power pin). In other words, one power (12V) pin is chosen as the redundant pin. A clock generator 406 then provides clock signal to the unconnected or redundant pin SS through the line 402B. It is appreciated that the signal source 406 may not necessarily provide clock signal. In this exemplary embodiment, a signal source 406 providing any signal distinguishable from the power level (e.g., 12V) will be adequate. For example, a signal source 406 providing, for example, 5V power level is sufficiently distinguishable from the 12V level.

Regarding the SSD 42 in FIG. 6A, the SATA SSD connector 422 includes al pins of the SATA output connector 403, and in particular the redundant pin SS is connected with a detection pin GPIO, which is further connected to a general purpose input/output (GPIO) unit 424 that is capable of detecting the presence or absence of the predetermined signal from the clock generator 406.

When the SSD 42 is configured to be indirectly connected to the host through the production tool 40 as shown in FIG. 6A, the GPIO unit 424 detects the presence of the generated clock signal from the clock generator 406 through the line 402B and pins SS and GPIO. Upon detection of the generated clock signal, the SSD 42 may then switch to the low-level format (LLF) mode to perform low-level format by the host. On the contrary, when the SSD 42 is configured to be directly connected to the host bypassing the production tool 40 as shown in FIG. 6B, the GPIO unit 424 detects the absence of the generated signal, and the SSD 42 may then switch to the normal mode.

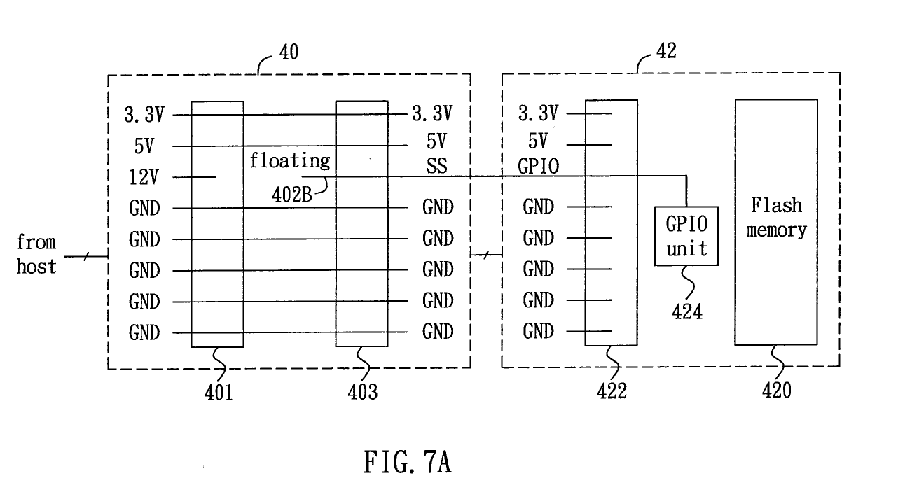

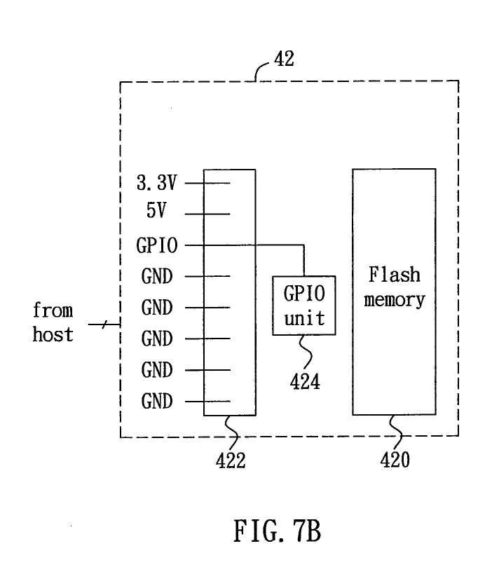

FIG. 7A shows a schematic diagram that illustrates a production tool 40 for low-level format of an SSD 42 (particularly a flash-based SSD) according to a specific third embodiment of the present invention.

Regarding the production tool 40 in FIG. 7A, the SATA input connector 401 includes, in the embodiment, portion of the SATA power segment: 3.3V, 5V, 12V, and five ground (GND) pins. The SATA output connector 403 includes all of these pins except one unused power pin (for example, 12V power pin). In other words, one power (12V) pin is chosen as the redundant pin. One end of the unconnected or redundant pin SS through the line 402B is floating. In this embodiment, the voltage level at the floating pin SS is sufficiently distinguishable from the 12V level.

Regarding the SSD 42 in FIG. 7A, the SATA SSD connector 422 includes al pins of the SATA output connector 403, and in particular the redundant pin SS is floating, which is further connected to a general purpose input/output (GPIO) unit 424 that is capable of detecting the presence or absence of the predetermined signal (i.e., the floating voltage level).

When the SSD 42 is configured to be indirectly connected to the host through the production tool 40 as shown in FIG. 7A, the GPIO unit 424 detects the presence of the floating voltage level. Upon detection of the floating voltage level, the SSD 42 may then switch to the low-level format (LLF) mode to perform low-level format by the host. On the contrary, when the SSD 42 is configured to be directly connected to the host bypassing the production tool 40 as shown in FIG. 7B, the GPIO unit 424 detects the absence of the floating voltage level, and the SSD 42 may then switch to the normal mode.

Although SATA interface standard is specifically illustrated in the embodiment, it is appreciated that the present invention may adopt other interface, such as eSATA (a variant interface of SATA), parallel ATA or peripheral component interconnect express (PCIe). Generally speaking, any interface (either standard interface or proprietary interface) that has redundant signal/power pin will be adequate in realizing the present invention. Furthermore, the storage device 42 of the present invention may be storage device other than the solid-state drive or hard disk drive.

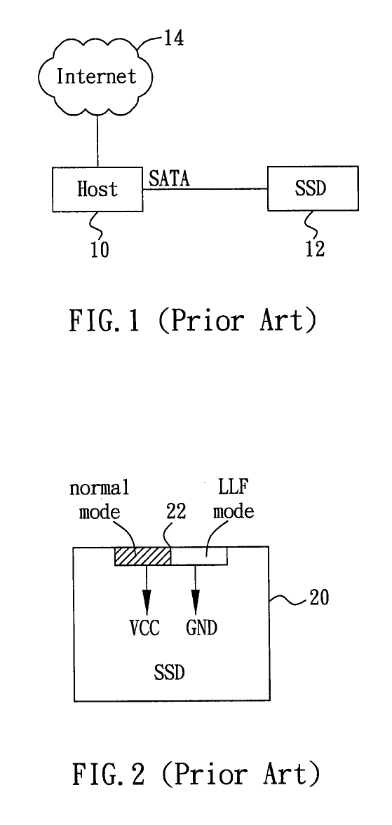

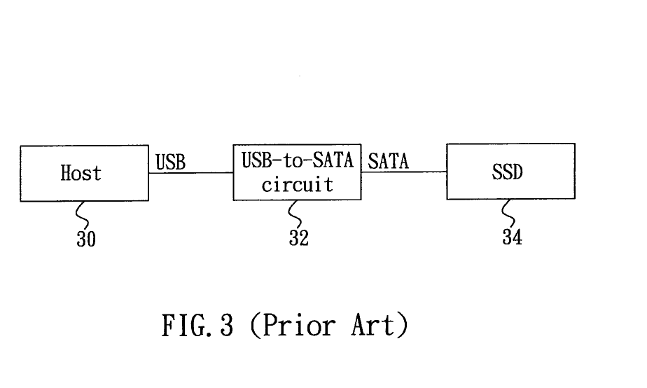

According to the embodiments discussed above, a simple and efficient scheme is provided for low-level format of storage device such as SSD. The disclosed novel scheme overcomes the disadvantage incurred in the scheme depicted in FIG. 1 without being liable to menace from the Internet. The disclosed novel scheme also eliminates inconvenience found in the scheme depicted in FIG. 2. The disclosed novel scheme further avoids the extra converting device such as the USB-to-SATA circuit 32 required in the scheme depicted in FIG. 3.

Although specific embodiments have been illustrated and described, it will be appreciated by those skilled in the art that various modifications may be made without departing from the scope of the present invention, which is intended to be limited solely by the appended claims.

What is claimed is:

1. A production tool for low-level format of a storage device, comprising:
an input connector connectable to a host; and
an output connector connectable to a storage device;
wherein the input connector conforms to an interface standard that is compatible with the interface standard of the output connector, and
at least a redundant pin of the input connector is unconnected with a corresponding redundant pin of the output connector, the redundant pin of the output connector being electrically connected to receive a provided predetermined signal, and presence of the provided predetermined signal indicating a low-level format mode.

2. The production tool of claim 1, wherein program is written to memory device of the storage device during process of the low-level format.

3. The production tool of claim 2, further comprising verifying the memory device during the process of the low-level format.

4. The production tool of claim 1, wherein the interface standard is a storage-interface standard defined for connecting the host to the storage device.

5. The production tool of claim 4, wherein the storage-interface standard is serial advanced technology attachment (SATA).

6. The production tool of claim 1, wherein the storage device is solid-state drive (SSD).

7. The production tool of claim 6, wherein the SSD is flash-based SSD.

8. The production tool of claim 1, wherein the provided predetermined signal in the redundant pin is detectable by a detector in the storage device.

9. The production tool of claim 1, further comprising a signal source that externally or internally provides the predetermined signal to the production tool.

10. The production tool of claim 1, wherein the provided predetermined signal is substantially distinguishable from a signal defined in the redundant pin of the input connector.

11. A production tool for low-level format of a solid-state drive (SSD), comprising:
a SATA input connector connectable to a host; and
a SATA output connector connectable to the SSD;
wherein the SATA input connector and the SATA output connector conform to the SATA interface standard, and
at least a redundant pin of the SATA input connector is unconnected with a corresponding redundant pin of the SATA output connector, the redundant pin of the SATA output connector being electrically connected to receive a predetermined signal that is substantially distinguishable from a signal defined in the redundant pin of the SATA input connector, and presence of the provided predetermined signal indicating a low-level format mode.

12. The production tool of claim 11, wherein program is written to memory device of the SSD during process of the low-level format.

13. The production tool of claim 12, further comprising verifying the memory device during the process of the low-level format.

14. The production tool of claim 12, wherein the SSD is flash-based SSD.

15. The production tool of claim 11, wherein the provided predetermined signal in the redundant pin is detectable by a detecting unit in the SSD.

16. The production tool of claim 15, wherein the detecting unit resides in a memory controller of the SSD.

17. The production of claim 16, wherein the detecting unit is a general purpose input/output (GPIO) unit that detects presence or absence of the provided predetermined signal through the redundant pin of the SATA output connector.

18. The production tool of claim 11, further comprising a clock generator that externally or internally provides clock signal to the production tool, and the clock signal is used as the predetermined signal.

19. The production tool of claim 11, wherein the redundant pin of the SATA input connector is a ground (GND) pin.

20. The production tool of claim 11, wherein the redundant pin of the SATA input connector is a power pin.
